(19) United States
(12) Patent Application Publication
(10) Pub. No.: US 2025/0095167 A1
(43) Pub. Date: Mar. 20, 2025

(54) MULTI-SUBJECT MULTI-CAMERA TRACKING FOR HIGH-DENSITY ENVIRONMENTS

(71) Applicant: NVIDIA Corporation, Santa Clara, CA (US)

(72) Inventors: Zheng TANG, Bothell, WA (US); Sujit BISWAS, San Jose, CA (US); Ganapathy Seshadri Cadungude AIYER, San Jose, CA (US); Shuo WANG, San Jose, CA (US); Akshay AGRAWAL, Santa Clara, CA (US); Sameer Satish PUSEGAONKAR, San Francisco, CA (US)

(21) Appl. No.: 18/618,974

(22) Filed: Mar. 27, 2024

Related U.S. Application Data
(60) Provisional application No. 63/539,325, filed on Sep. 19, 2023.

(51) Int. Cl. G06T 7/292; G06V 10/762

(52) U.S. Cl. CPC G06T 7/292; G06V 10/762

(57) ABSTRACT

In various examples, multi-subject multi-camera tracking for high-density environments is provided. In some embodiments, an MTMC tracking system may associate previously initialized behavior states with currently generated behaviors clusters based on selecting between subject trajectory tracking and cluster matching algorithms. The system may receive image data comprising feeds from a plurality of optical images sensors. The system may generate behavior clusters and apply trajectory tracking to determine if the prior behavior states can be propagated based on a continuity of trajectory analysis. If behavior clusters cannot be associated based on trajectory tracking, a matching algorithm may be applied to the set of behavior clusters. For matched clusters, a matched a prior behavior state may be assigned to the cluster and propagated forward. If a cluster does not match with a prior behavior state, a new global ID and behavior state may be initialized based on representations forming the cluster.

### CROSS-REFERENCE TO RELATED APPLICATIONS

This application claims the benefit of, and priority to, U.S. Provisional Application No. 63/539,325, titled, “Cloud-Native System for Multi-Target Multi-Camera Tracking Using Hierarchical Clustering and Hungarian Matching” filed on Sep. 19, 2023, which is hereby incorporated by reference in its entirety.

### BACKGROUND

Multi-subject multi-camera (MTMC) tracking is a computer vision-based technology that simultaneously monitors and tracks the movements of numerous objects (subjects) across multiple camera views—taking input from video feeds captured by multiple (potentially non-overlapping) cameras, and applying algorithms and/or machine learning techniques to analyze video streams to track and identify subjects of interest. MTMC tracking may be used in applications such as security and surveillance, vehicle traffic monitoring, monitor activities in transit, factories and warehouses, in retail analytics to monitor customer behaviors in a retail store, and/or crowd management/public safety at events, gatherings, or public spaces.

### SUMMARY

Embodiments of the present disclosure relate to multi-subject multi-camera tracking for high-density environments. Systems and methods disclosed herein for an MTMC tracking system may be used to track the location and movements of a plurality of subjects within a monitored area based on image data captured by a plurality of optical image sensors.

In contrast to existing MTMC tracking technologies, the systems and method described herein provide for an MTMC tracking system that associates previously initialized behavior states with currently generated behaviors clusters based on selecting between subject trajectory tracking and cluster matching algorithms. The MTMC tracking system may receive a set of synchronized optical image streaming data that comprises, for example, video image feeds from a plurality of optical images sensors. The video image feeds may be synchronized such that the streaming data comprises individual image feeds from different optical images sensors that capture image data at the same time. The MTMC tracking system processes the synchronized optical image streaming data as sequential batches. For each batch, the MTMC tracking system performs a clustering process to generate one or more behavior clusters. Each behavior cluster represents a trackable subject within an area monitored by the plurality of optical images sensors. A monitored area may comprise any area within which subjects of interest may be traveling such as, but not limited to, warehouses, factories, retail establishments, office buildings, secured facilities, arenas, public transportation stations, parks, public spaces, and the like.

Video image feeds from the individual cameras may be processed using computer-based perception to perform behavior detection, and further perform tracking (e.g., subject behavior localization) and generate representations (e.g., behavior embeddings) for each detected behavior. A representation may include encoded behavior data comprising appearance data and/or spatiotemporal data capturing characteristics of a tracked subject. The representations may be computed based on behaviors detected, for example, by a machine learning model trained to recognize characteristics of intended subjects. Based on a set of representations computed from a batch of the synchronized optical image streaming data across the multiple sensors, the spatiotemporal data from each behavior embedding may be mapped to a global image coordinate system and an initial clustering may be performed to group representations into clusters based on their similarity. The MTMC tracking system may generate behavior clusters and apply trajectory tracking to determine if prior trajectory states can be propagated based on a continuity of trajectory analysis that associates prior behavior states (from the prior batch of streaming data) with representations derived from the current batch of streaming data. When each of the clusters generated from the current batch of optical image data can be successfully associated with a global ID and a prior behavior state based on the trajectory analysis, then each prior behavior state may be propagated by updating the prior behavior state using the current behavior data from its associated current cluster.

If one or more behavior clusters cannot be associated with a global ID based on the trajectory analysis, then those additional clusters may represent behaviors associated with one or more new subjects not previously observed by the MTMC tracking system, or alternatively represent one or more subjects that may have been previously associated with a global ID that has become a dormant global ID. The MTMC tracking system may apply a matching algorithm to the set of behavior clusters. For each behavior cluster, the matching algorithm may determine if the representations forming that cluster are a match with the appearance and spatiotemporal data associated with a prior behavior state. If so, then the global ID associated with that prior behavior state may be assigned to the cluster and propagated forward to the current processing iteration by updating the prior behavior state based on the current appearance data and/or spatiotemporal data from its associated current behavior cluster. If a cluster is determined by the matching algorithm to not match with a previously initialized behavior state, then that cluster may represent behaviors associated with a subject not previously observed by the MTMC tracking system. In that case, the MTMC tracking system may initialize a new global ID assigned to represent that subject, and initialize a behavior state for the new global ID based on the current representations forming the cluster.

Subject tracking data derived from behavior states of live anchors may be used as input, for example, by one or more subject evaluation systems. In some embodiments, the MTMC tracking system may use the updated behavior states of global IDs to render a user interface (UI) on a human machine interface display. The UI may present a comprehensive computer vision-based view of the monitored area. In some embodiments, a navigation control system for a mobile machine, such as an automated mobile robot (AMR) and/or an ego-machine, may dynamically route the mobile machine away from using a path that may be congested by the presence of subjects (e.g., people) on the path. In some embodiments, the MTMC tracking system may integrate query by example (QBE) functionality, utilizing global IDs and representations produced by the MTMC tracking system, stored in a database (e.g., a Milvus database, vector database, and/or other vector database management system (VDBMS)) to support long-term QBE queries spanning over selected time periods.

### BRIEF DESCRIPTION OF THE DRAWINGS

The present systems and methods for multi-subject multi-camera tracking for high-density environments are described in detail below with reference to the attached drawing figures, wherein:

FIG. 1 is a data flow diagram illustrating a multi-subject multi-camera tracking system, in accordance with some embodiments of the present disclosure;

FIG. 2 is a data flow diagram illustrating a behavior extraction process, in accordance with some embodiments of the present disclosure;

FIG. 3 is a data flow diagram illustrating a multi-subject multi-camera tracking system behavior state management process, in accordance with some embodiments of the present disclosure;

FIGS. 4A and 4B are diagrams that illustrate example user interface displays generated by a multi-subject multi-camera tracking system, in accordance with some embodiments of the present disclosure;

FIG. 5 is a flow chart illustrating a method for a real-time location system, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

Systems and methods disclosed relate to multi-subject multi-camera tracking for high-density environments.

Historically, camera-based tracking technologies have involved either single object tracking (SOT) or multi-object tracking (MOT) that uses image data from a single camera. More recently, multi-camera based tracking has leveraged developments in multi-camera networks to apply techniques for providing comprehensive monitoring of an area from multiple viewpoints. However, multi-camera tracking introduces complexities with respect to tracking subjects across multiple camera views-including performing accurate synchronization and calibration between the cameras, addressing appearance changes in a subject that may vary with viewpoint, and fusing data from different video streams to distinctly define subjects and associated trajectory tracks.

While object Re-identification (Re-ID) and other advanced matching algorithms for tracking subjects have been developed that can take the outputs of object detection algorithms and match them to compute individual trajectories, those techniques face difficulties with respect to scalability. Matching may be performed using clustering, however standard clustering techniques are not scalable with respect to Re-ID based multi-camera tracking as the number of cameras capturing subjects from different viewpoints increases. For example, if a monitored area has 5 cameras to track 10 subjects moving about the area, then potentially up to 50 distinct behavior detections may need to be processed and linked to individual subjects appearing in the video streams, and their respective trajectories tracked across camera views over time. If a monitored area has 100 cameras to track 10 subjects moving about the area, then potentially up to 1,000 distinct behavior detections may need to be processed and individually linked to subjects appearing in the video streams, and their respective trajectories tracked over time. For a monitored area where a large number of cameras are used (e.g., such as a warehouse or factory) the number of distinct behavior detections that need to be simultaneously processed into distinct subjects (including their respective trajectory data) can quickly overburden the abilities of available compute resources used by the various algorithms to support MTMC tracking.

In contrast to existing MTMC tracking technologies, the systems and method described herein provide for MTMC tracking that associates previously initialized behavior states with currently generated behaviors clusters based on subject trajectory tracking based on selecting between subject trajectory tracking and cluster matching algorithms. As discussed herein, a MTMC tracking system may receive a set of synchronized optical image streaming data that comprises, for example, video image feeds from a plurality of optical images sensors. The video image feeds may be synchronized such that the streaming data comprises individual image feeds from different optical images sensors that capture image data at the same time. In some embodiments, the video image feeds may include timestamps that can be used to align contemporaneously captured image data from the multiple feeds. The MTMC tracking system may process the synchronized optical image streaming data as sequential batches (e.g., where each batch defines a distinct time frame of the synchronized optical image streaming data). For each batch, the MTMC tracking system may perform a clustering process (described below) to generate one or more behavior clusters (e.g., a cluster including a set of similar detected behaviors). Each behavior cluster represents a trackable subject within an area monitored by the plurality of optical images sensors. In some embodiments, the synchronized optical image streaming data may comprise live-streaming feeds from the plurality of optical image sensors. In some embodiments, the synchronized optical image streaming data may comprise batches of previously recorded live-streaming feeds from the plurality of optical image sensors. A monitored area may comprise any area within which subjects of interest may be traveling such as, but not limited to, warehouses, factories, retail establishments, hospitals, office buildings, secured facilities, arenas, public transportation stations, parks, public spaces, and the like.

Video image feeds from the individual cameras may be processed using computer-based perception to perform behavior detection, and further perform single camera tracking (e.g., subject behavior localization), and generate representations of subject behavior (e.g., behavior embeddings which may include a vector representing a subject) for each detected behavior. A representation may include encoded behavior data comprising appearance data and/or spatiotemporal data capturing characteristics of a tracked subject. The representations may be computed based on behaviors detected, for example, by a machine learning model trained to recognize characteristics of intended subjects (e.g., a model trained to recognized and extract features associated with characteristics of people, vehicles, machines, animals, and/or other subjects of interest). In some embodiments, the MTMC tracking system may implement a plurality of parallel data processing paths for processing the feeds from the plurality of cameras. For example, in some embodiments the MTMC tracking system may implement a set of parallel processing paths (e.g., using multiple processing threads and/or multiple core processors) for computing the behavior embedding, where each processing path generates representations (e.g., behavior embeddings) based on the feed of a respective camera. Representations that cluster together to form a behavior cluster may be used to define and/or update a behavior state of a subject as it is tracked through the monitoring area.

Based on a set of representations computed from a batch of the synchronized optical image streaming data across the multiple sensors, the spatiotemporal data from each behavior embedding may be mapped to a global image coordinate system (e.g., based on extrinsic camera calibration parameters associated with each of the individual cameras) and an initial clustering may be performed to group representations into clusters based on their similarity. For example, a person in a monitored area may be represented in the batch of synchronized optical image streaming data as a detected subject, and represented as a first behavior embedding derived from the feed of a first camera and as a second behavior embedding derived from the feed of a second camera. For each camera, a set of extrinsic calibration parameters (e.g., a rotation-translation transform) may be determined and used to map location information of behaviors extracted from two-dimensional (2D) image data captured by the camera, to a global coordinate system associated with the monitored area. Since the first behavior embedding and the second behavior embedding in this example are both are representations of the same subject (person) within the same time frame, the first behavior embedding and the second behavior should share very similar behavior data (e.g., appearance data and spatiotemporal data). Those behavior embedding therefore would form a cluster that can be uniquely associated with a distinct subject (e.g., the detected person). Moreover, for each additional camera that observes that subject during the timeframe, those behavior embedding should also cluster with the representations derived from the first and second cameras. Other distinct clusters may form in the same way based on representations associated with other subjects represented in the batch of streaming data.

In some embodiments, when the MTMC tracking system performs clustering, an agglomerative clustering may be performed to group representations into clusters based on their similarity. In some embodiments, the MTMC tracking system may apply one or more hierarchical clustering algorithms such as, but not limited to, a balanced iterative reducing and clustering using hierarchies (BIRCH) algorithm, a Ordering points to identify the clustering structure (OPTICS) algorithm, a Density-based spatial clustering of applications with noise (DBSCAN), a hierarchical DBSCAN (HDBSCAN*), and/or other clustering algorithms.

In some embodiments, to initialize the MTMC tracking system an initial batch of streaming data may be processed to generate an initial set of behavior clusters from an initial set of representations of behavior computed from the image data—and initial behavior states initialized for each cluster. In one or more embodiments, the representations of behavior are implemented as behavior embeddings. An initialized behavior state may include an amalgamation of appearance data and spatiotemporal data for a tracked subject based on the representations that form a cluster. Each initialized behavior state may be assigned a global identification (global ID) representing a trackable subject whose trajectory is detectable from the initial batch of streaming data. In some embodiments, a global ID may be an anonymized identifier, and/or may correlate to a more personal identifier such as a subject's employee number, customer number, account number, student number, or other identifier associated with a tracked subject.

For subsequent batches of the synchronized optical image streaming data (e.g., subsequent time frames) the MTMC tracking system may generate behavior clusters and apply trajectory tracking to determine if the behavior states can be propagated based on a continuity of trajectory analysis that associates prior behavior states (from the prior batch of streaming data) with representations derived from the current batch of streaming data. When each of the clusters generated from the current batch of synchronized optical image streaming data can be successfully associated with a global ID (e.g., with a prior behavior state) based on the trajectory analysis, then each prior behavior state may be propagated by updating the prior behavior state using the current behavior data from its associated current cluster. Incremental changes in either the appearance, location, and/or trajectory of a subject may be incorporated into the behavior state data maintained for subject's global ID by the MTMC tracking system. In some embodiments, updated behavior state data may comprise a statistically weighted fusion of prior and current appearance and spatiotemporal data. In some embodiments, the behavior state for a global ID may represent a subject for a moving window of time. For example, the behavior state may represent appearance and spatiotemporal data based on behavior embedding obtained over the last “t” seconds of time (e.g., over the last 5 or 10 seconds), so that trajectory and rendered tracking data may be computed based on period of recent movements by the subject.

If one or more clusters formed from the current batch of synchronized optical image streaming data cannot be associated with a global ID based on the trajectory analysis, then those additional clusters may represent behaviors associated with one or more new subjects not previously observed by the MTMC tracking system, or alternatively represent one or more subjects that may have been previously associated with a global ID that has become a dormant global ID. For example, a dormant global ID may represent a previously initialized behavior state associated with a subject that has not been detected in the most recent previous batches of streaming data for a predetermined period of time (e.g., due to leaving the monitored area and/or due to an occlusion). In contrast, a live global ID may represent a previously initialized behavior state associated with a subject that has been detected from the most recent batches of streaming data. When a subject associated with a dormant global ID once again becomes detectable from the synchronized optical image streaming data, it may be desirable to associate their behaviors with their prior global ID (which may have become dormant) rather than treat them as an entirely new subject with a newly assigned global ID.

In some embodiments, to more precisely determine whether one or more of the behavior clusters should be associated with a live global ID, associated with a dormant global ID, or treated as a new subject and assigned a new global ID, the MTMC tracking system apply a matching algorithm to the set of behavior clusters. For each behavior cluster, the matching algorithm may determine if the representations forming that cluster are a match with the appearance and spatiotemporal data associated with a prior behavior state for a live of dormant global ID. If so, then the global ID associated with that prior behavior state may be assigned to the cluster and propagated forward to the current processing iteration by updating the prior behavior state based on the current appearance data and/or spatiotemporal data from its associated current behavior cluster. Moreover, if the previously initialized behavior state was associated with a dormant global ID, that global ID may be reclassified as an active (or live) global ID since it once again now represent the behavior state of a subject actively appearing in the current batch of synchronized optical image streaming data.

In some embodiments, the MTMC tracking system may use a configurable state retention time for determining the duration a dormant anchor can remain eligible for reclassification back to being live anchor. If a dormant anchor has remained dormant for longer than the state retention time, then it may expire. For example, given a configurable state retention time of 10 minutes, the MTMC tracking system would trigger initialization of a new global ID for a tracked subject reappearing 15 minutes after becoming dormant. After a global ID has been dormant for longer than the configurable state retention time, the MTMC tracking system may delete the expired dormant global ID (e.g. so that it cannot be reactivated as a live global ID). In some embodiments, historical behavior data and/or behavior states associated with a deleted global ID may be maintained in a database for later analysis (e.g., using a QBE functionality as described below).

If a cluster is determined by the matching algorithm to not match with a previously initialized behavior state, then that cluster may represent behaviors associated with a subject not previously observed by the MTMC tracking system. In that case, the MTMC tracking system may initialize a new global ID assigned to represent that subject, and initialize a behavior state for the new global ID based on the current representations forming the cluster. Each behavior cluster that could not be matched by the matching algorithm to a prior behavior state may similarly represent a new subject and used to initialize a global ID.

In some embodiments, the MTMC tracking system may comprise a machine learning model trained to perform the behavior detection and tracking, and to derive the representations. The machine learning model may comprise, for example, a re-identification (Re-ID) embedding model that encodes the appearance of each tracked subject. Optical image data comprising an image of a subject may be used to generate a bounding shape (e.g. box) for the subject, and to crop the optical image data to the bounding shape. The Re-ID embedding model may output a behavior embedding for the cropped image that comprises and embedding vector. The behavior embedding may encode one or both of appearance data and spatiotemporal data (e.g., location and/or trajectory) that characterizes a subject. In some embodiments, the machine learning model may comprise a ResNet50 backbone architecture, or other deep neural network architecture. In some embodiments, the machine learning model may comprise a transformer-based Re-ID model. For example, the machine learning model may comprise a re-identification network based on a transformer architecture to generate embeddings for identifying subjects captured in different scenes and encoding behavior data.

In some embodiments, when clustering of representations is performed by the MTMC tracking system, the MTMC tracking system may perform a two-step hierarchical clustering process. In the first step of the clustering process, the set of behavior embedding may be clustered based on the similarity of their representations.

This first step of the clustering process is used to predict a number (e.g., a subject prediction number) representing how many clusters correlate with actual subjects represented by the representations. The first step of the clustering process may be based on applying a fine-tuned clustering threshold parameter to the representations. That is, the clustering threshold parameter may define a criteria for how tightly clustered (e.g., how close in distance) a set of representations need to be for that set of representations to be considered a cluster. The clustering threshold parameter may, in some embodiments, comprise a clustering Quality Threshold (QT) specifying a threshold distance between members of the cluster and/or a minimum number of representations that are to be within the threshold distance of each other for the set to be considered a cluster. In the second step of the clustering process, clustering is again performed using the set of behavior embedding based on the similarity of their representations, and further based on constraining the clustering based on the subject prediction number derived from the first step of the clustering process. That is, the second step of the clustering process is constrained to cluster the representations into a number of clusters that corresponds to the number of subjects that are predicted to be present in the current batch of streaming data.

Since each cluster produced from the second step of the clustering process are expected to comprise representations representative of the same distinct subject, the appearance data and/or the spatiotemporal data encoded in the representations with each cluster should be highly similar—and readily distinguishable from the appearance data and the spatiotemporal data provided by the representations of other clusters that represent other distinct subjects within the monitored area. Advantageously, using the two-step clustering the processes of initializing new anchors from the resulting clusters and/or reclassifying dormant anchors as live anchors both may benefit from a high degree of confidence that the representations of each cluster correspond to a distinct subject distinguishable from other subjects. The MTMC system offers superior accuracy due to its ability to analyze a relatively larger data window for clustering.

In some embodiments, when the MTMC tracking system performs the two-step hierarchical clustering process, the process may use Re-ID appearance data from the representations without integrating spatiotemporal data. The spatiotemporal information may be subsequently incorporated in the re-assignment phase through matching process, where both spatiotemporal and Re-ID distances may be normalized and weighted for decision-making. At each iteration of the matching processes, the appearance data and spatiotemporal data (e.g., locations) of the clusters may be updated and optimized.

As discussed above, in some embodiments the clustering process may be followed by a matching process to determine if the representations associated with a cluster match with (e.g., are similar to) representations associated with a previously initialized behavior state. In some embodiments, the matching may be performed using an iterative matching combinatorial optimization algorithm (e.g., a matching algorithm that solves an assignment problem by matching agents to tasks). In some embodiments, the matching process may apply a Hungarian matching algorithm, which may be referred to as a Kuhn-Munkres algorithm or a Munkres assignment algorithm, to assign a cluster produced by the clustering process to a previously initialized behavior state (whether for a current or dormant global ID), by attempting to match representations of each cluster to representations of previously initialized behavior states (e.g., based on similarity). In some embodiments, iterative refinement may include sufficient iterations to obtain an optimal matching accuracy saturation (e.g., approximately 10 iterations in the case of a Hungarian matching algorithm). If a cluster is assigned (matched) to a previously initialized behavior state, then the MTMC tracking system may apply behavior state management to update the behavior state for that global ID based on the appearance data and the spatiotemporal data provided by the current representations from the cluster. If the matching algorithm determines that a cluster cannot be assigned (matched) to a previously initialized behavior state, then a new global ID may be initialized for that cluster, with its initial behavior state defined based on the appearance data and the spatiotemporal data provided by the current representations from the cluster.

As discussed above, the MTMC tracking system may apply state management to update behavior states based on appearance data and/or spatiotemporal data provided by current behavior embedding from the current batch of streaming data. For example, in in some embodiments, the MTMC tracking system may determine the current representations associated with a behavior cluster from the current batch of streaming data, and the representations as represented by the prior behavior state of global ID, and produce an updated behavior state based on the representations from the cluster. In this way, the behavior state for a global ID assigned to a subject may be updated based on current appearance data for the subject, and/or based on the current location and/or trajectory data for the subject. In some embodiments, updating may comprise a fusing or stitching of behaviors represented by current and prior/historical representations. A behavior state for a global ID thus may comprise both current and historical appearance data and/or spatiotemporal data. In some embodiments, the appearance data and/or spatiotemporal data provided by current representations may be weighed differently than appearance data and/or spatiotemporal data in the behavior state provided by prior representations. As an example, a set of historical appearance, location and/or trajectory data for global ID may be considered more reliable than current appearance, location and/or trajectory data. As such when the behavior state is updated, the historical appearance, location and/or trajectory data may be given a high weighting (e.g., 0.9) while the current appearance, location and/or trajectory data is given a relatively lower weighting (e.g., 0.1), as the data is combined to update the behavior state. Conversely, if the MTMC tracking system is updating a behavior state of from a dormant global ID that has been reclassified as a current global ID, the current appearance, location and/or trajectory data may be more accurate than the historical appearance, location and/or trajectory data, depending on how long the global ID was a dormant global ID. In such a case, the historical appearance, location and/or trajectory data may be given a lower weighting (e.g., 0.1) while the historical appearance, location and/or trajectory data is given a relatively higher weighting (e.g., 0.9), as the data is combined to update the behavior state. In some embodiments, a behavior state may maintain historical appearance data and/or spatiotemporal data for a predetermined duration, and purge historical data from the behavior state based on age and/or other data staleness criteria. For example, in some embodiments, a behavior state may maintain the prior 5 or 10 seconds of historical appearance, location and/or trajectory data for subject.

In some instances, overlapping behavior may occur when two tracked subjects appearing in the video feed captured from a single camera appear sufficiently similar to have been assigned the same global ID and/or having behavior embeddings assigned to the same cluster. Such overlapping behavior may result from, for example, two or more subjects with similar appearance that overlap with each other in position from the view of one or more of the multiple image sensors. In some embodiments, the MTMC tracking system may therefore implement overlapping behavior suppression (e.g. using linear programming). The overlapping behavior suppression may compute distance information between distinct representations and compute optimal paths for each subject's bounding shape appearing in the feed of a single camera, given the constraint that a global ID from a prior behavior state cannot be assigned to behaviors detected from two distinct bounding shapes appearing in the feed.

Subject tracking data derived from behavior states of live anchors may be used as input, for example, by one or more subject evaluation systems. Subject tracking data may be used by a rendering system to display a comprehensive view of the monitored area and visually render location and trajectory tracking data for each subject in the area, where the rendering system may benefit from having an accurate spatiotemporal understanding of the location and movements of subjects of interest within the monitored area. This may include switching between real and/or virtual camera views while tracking a subject moving through the area to locate a current position of a specific subject within the area (e.g., based on a global ID or other query).

In some embodiments, the MTMC tracking system may use the updated behavior states of global IDs to render a user interface (UI) on a human machine interface display. The UI may present a comprehensive computer vision-based view of the monitored area. For example, the MTMC tracking system may use the location and/or trajectory data for each global ID to display a predicted location and/or tracking information associated with each subject. In some embodiments, the MTMC tracking system may generate a computer-vision based display of a top-down (birds-eye) view of the monitored area-displaying the location and/or tracking of each tracked subject. The MTMC tracking system may generate a display of a computer-vision based environment corresponding to a viewpoint of one or more of the real image sensors providing the streaming data, and/or of a viewpoint of one or more virtual camera views instantiated within the computer-vision based environment. In some embodiments, a subject may be selected via the user interface and their movements tracked through the computer-vision based environment based on the behavior state of the subject's associated global ID. The global ID (or other corresponding identifier) may be displayed for one or more of the subjects tracked through the monitored area by the MTMC tracking system.

In some embodiments, a navigation control system for a mobile machine, such as an automated mobile robot (AMR) and/or an ego-machine, may dynamically route the mobile machine away from using a path that may be congested by the presence of subjects (e.g., people) on the path. In some embodiments, the MTMC tracking system may implement an application programming interface (API) to facilitate an AMR integration for communicating tracked subject movements to an AMR control system, and/or display tracked subjects relevant to an AMR on a user interface (UI) as described below. In some embodiments, the output from the MTMC tracking system may be used by a security system to track a person of interest in real time as they traverse through the monitored area.

In some embodiments, the MTMC tracking system may integrate query by example (QBE) functionality, utilizing global IDs and representations produced by the MTMC tracking system, stored in a database (e.g., a Milvus database, vector database, and/or other vector database management system (VDBMS)) to support long-term QBE queries spanning over selected time periods. The QBE functionality may operate based on representational state transfer (REST) application programming interface (API inputs), that may include one or more of, but not limited to, an object ID, a sensor ID, a timestamp, optional parameters like time range, match score threshold, and/or top K matches, for obtaining similar behaviors. The QBE functionality may normalizes the representations before searching in the database for similar ones, and the matched behaviors may have IDs used by the REST API to fetch behavior metadata using a search engine (e.g., Elasticsearch). This search capability of the QBE functionality may provide for precise and efficient retrieval of relevant tracked subject behavior patterns over extended periods.

Because the MTMC tracking system initializes global IDs, and updates behavior states of global ID from batch to batch of synchronized optical image streaming data based on tracking trajectory, the execution of complex matching algorithms may be limited to those instances where a batch of streaming data comprises representations not already associated with a previously initialized behavior state. That is, the MTMC tracking system may selectively execute the matching algorithm for those batches that include clusters of behavior embedding that cannot be associated with global IDs based on trajectory tracing. Such a process beneficiary conserves computing resources to increase efficiency, which permits a MTMC tracking system to provide subject tracking using a greater number of image sensors within the monitoring area that previously achievable for a given set of computing resources.

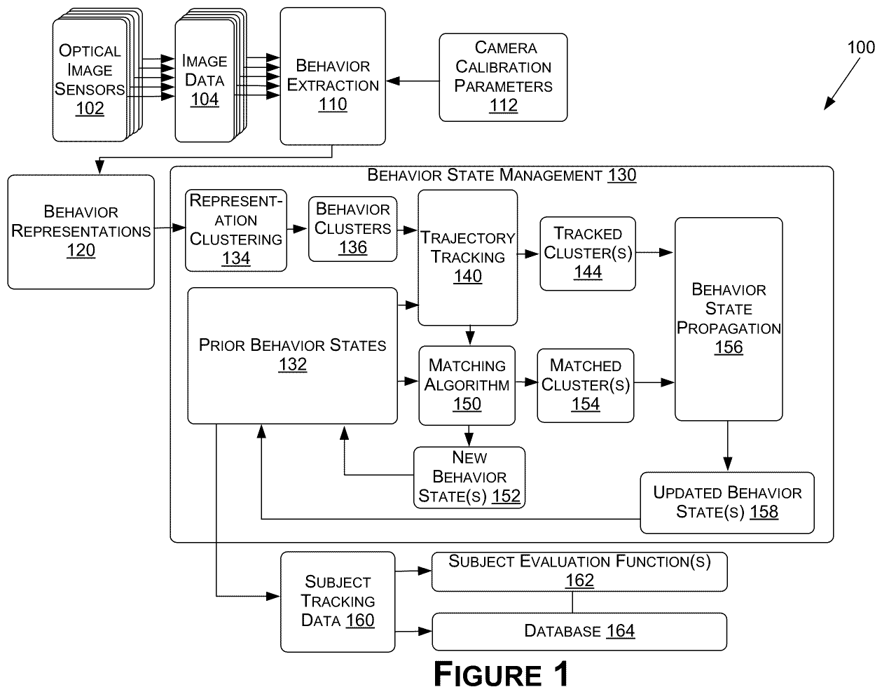

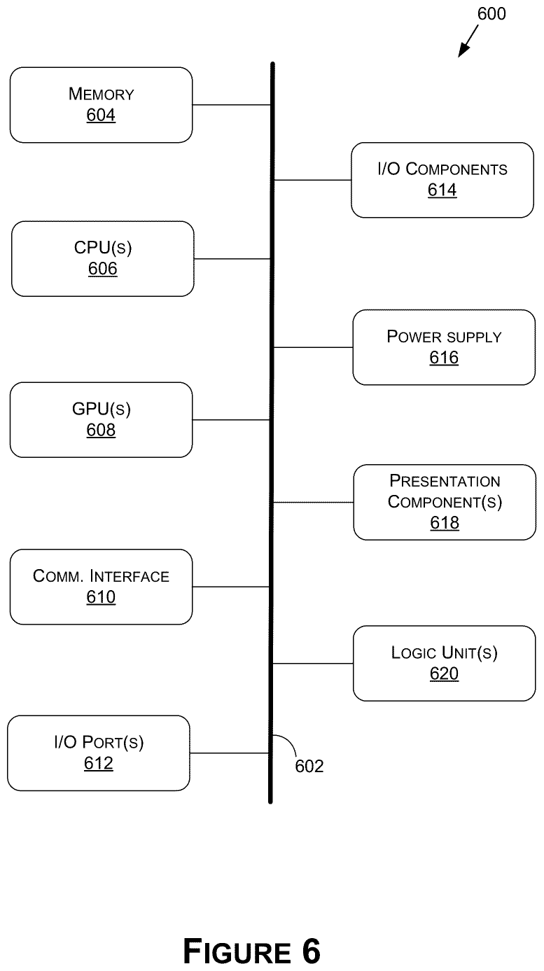

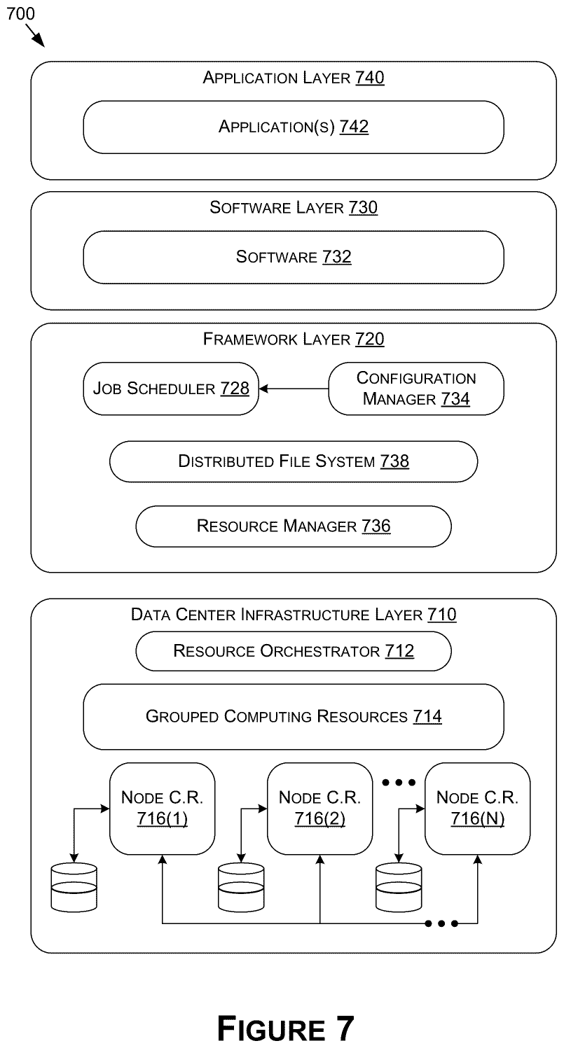

FIG. 1 is an example data flow diagram for a MTMC tracking system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by one or more processors (e.g., processing units, processing circuitry) executing instructions stored in memory. In some embodiments, the systems, methods, and processes described herein may be executed using similar components, features, and/or functionalities to those of example computing device 600 of FIG. 6, and/or example data center 700 of FIG. 7.

As shown in FIG. 1, the MTMC tracking system 100 may receive image data 104 from a plurality of optical image sensors 102 (e.g., cameras) to track the location and trajectory of a plurality of subjects within a monitored area based on behavior states initialized and updated for those tracked subjects using behavior data extracted from the image data 104. In some embodiments, the image data 104 includes synchronized optical image streaming data based on live-streaming feeds from the plurality of optical image sensors 102. In some embodiments, the image data 104 includes synchronized optical image streaming data based on batches of previously recorded live-streaming feeds from the plurality of optical image sensors 102.

The image data 104 may include individual video image feeds that are synchronized such that the streaming data comprises individual image feeds from distinct optical images sensors 102 that capture image data at the same time. The video image feeds may include timestamps that can be used to align contemporaneously captured image data from the multiple feeds. The MTMC tracking system 100 may process the image data 104 as sequential micro-batches, for example where each micro-batch defines a distinct sub-second time frame of the image data 104. In some embodiments, the optical image sensors may comprise, for example, one or more RGB cameras, one or more IR cameras, one or more RGB-IR cameras, and/or one or more cameras as discussed with respect to computing device 600 discussed below.

The image data 104 may be processed using behavior extraction 110 to extract representations 120 that represent individual behaviors of tracked subjects represented in the image data 104. That is, each behavior embedding 120 may comprise a representation of a tracked subject as appearing in an individual feed of image data 104 associated with a distinct one of the optical image sensors 102. The representation provided by representations 120 may comprise behavior data that includes appearance data (e.g., characterizing the appearance of the tracked subject) and/or spatiotemporal data (e.g., characterizing the location and/or trajectory of the tracked subject with respect to the monitored area. As discussed herein, each of the optical image sensors 102 may capture image data 104 based on their particular view of the monitored area, which is at least in part a function of the extrinsic camera calibration parameters 112 (e.g., one or more rotation-translation transforms) associated with each of the individual optical image sensors 102. Accordingly, the spatiotemporal data represented by representations 120 may be mapped, using the camera calibration parameters 112, to a global coordinate system associated for the monitored area-thus facilitating the correlation of spatiotemporal data from the representations 120 for clustering, matching, trajectory tracking, and/or other purposes.

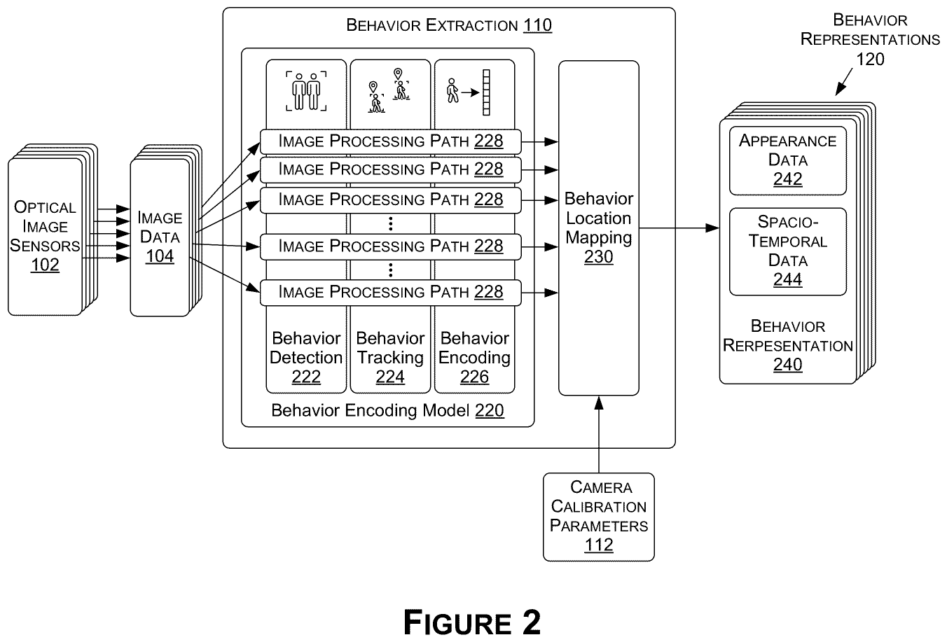

FIG. 2 is a data flow diagram illustrating the operation of behavior extraction 110 to extract representations 120 from the image data 104. As shown in FIG. 2, the behavior extraction 110 may implement a plurality of parallel data processing paths 228, where each path 228 may independently process a feed of the image data 104 associated with one of the optical image sensors 102. Within each path 228, the behavior extraction 110 may perform behavior detection 222, behavior tracking 224 and/or behavior encoding 226. The behavior detection 222 may function to recognize and extract features corresponding to behaviors for tracked subjects as observed in each processing path 228 (e.g., people, vehicles, machines, animals, and/or other subjects of interest). In some embodiments, optical image data 104 comprising an image of a subject may be used by the behavior detection 222 to generate a bounding shape for one or more subjects, and for each subject produce subject specific optical image data cropped to the bounding shape. Behavior tracking 224 may function to compute spatiotemporal characteristics associated with each detected behavior associated with a tracked subject, such as location and trajectory (speed, and direction of movement) with respect to the local image frame of a sensors that captured the image data. Behavior encoding 226 may generate encodings of the appearance data and spatiotemporal data associated with each of the behaviors detected from the image data, which are used to produce the representations 120. Also as shown in FIG. 2, as each of the processing paths 228 is associated with a different optical image sensor 102 that may capture image data 104 based on their particular view of the monitored area. In some embodiments the behavior extraction 110 may further include behavior mapping 230 that applies the camera calibration parameters 112 to map the spatiotemporal data associated with each behavior to the global coordinate system associated with the monitored area. The resulting output from the behavior extraction 110 may comprise a plurality of representations 120, where each individual representation 240 may comprise behavior data (e.g., appearance data 242 and/or spatiotemporal data 244) representing a tracked subject as that tracked subject appears in an individual feed of image data 104 associated with a distinct one of the optical image sensors 102.

In some embodiments, one or more of the behavior detection 222, behavior tracking 224 and/or behavior encoding 226 may be performed by the behavior extraction 110 using a behavior encoding model 220 (e.g., a machine learning model). The behavior encoding model 220 may comprise, for example, a re-identification (Re-ID) embedding model that encodes the appearance of each tracked subject appearing in the image data 104 carried by the processing paths 228. In some embodiments, based on the optical image data 104 comprising an image of a tracked subject, the behavior encoding model 220 may generate a bounding shape (e.g., box) around a detected behavior and crop the optical image data to the bounding shape. For example, an image of a detected behavior for a subject may be cropped and the cropped images resized, for example, to a 256×128 pixel image. The behavior encoding model 220 may output a representation 240 corresponding to the cropped image. In some embodiments, a representation 240 may be structured in the form of an embedding vector. The embedding vector may comprise, for example a vector with a dimension is configurable in size from 1 to 2048 elements. In some embodiments, an embedding vector may have a default size of 256. A representation 240 computed by the behavior encoding model 220 may encode one or both of appearance data 242 and spatiotemporal data 244 that characterizes a tracked subject. In some embodiments, the behavior encoding model 220 may comprise a ResNet50 backbone architecture, or other deep neural network (DNN) architecture. The behavior encoding model 220 may be trained with a combination of triplet loss, center loss and ID loss (e.g., cross entropy loss). Re-ID features may be used to compute the triplet loss, which minimizes the embedding distance of behaviors associated with the same subject (positive samples), while maximizing the distance of other behaviors associated with the different subjects (negative samples). In some embodiments, the behavior encoding model 220 may comprise a transformer-based Re-ID model. For example, the behavior encoding model 220 may comprise a re-identification network based on a transformer architecture to generate embeddings for identifying subjects captured in different scenes and encoding behavior data. In some embodiments, the behavior encoding model 220 may be executed on one or more GPU (e.g., one or more of the GPU(s) 608 as discussed below with respect to FIG. 6).

Returning to FIG. 1, the MTMC tracking system 100 may comprise behavior state management 130 that produces and maintains behavior states for tracking subjects that are observable within the monitored area. More specifically, the behavior state management 130 maintains a set of prior behavior states 120 that each represent the appearance and movements of a tracked subject over time, and that may be iteratively updated based on each iteration of new time frames of image data 104. The behavior state management 130 applies representation clustering 134 to the representations 120 to produce behavior clusters 136. The prior behavior states 120 may then be updated to include the behavior data for one or more tracked subjects as represented in the resulting behavior clusters 136. Representation clustering 134 may perform a clustering of the representations 120 based on similarity of behavior data (e.g., appearance data and/or spatiotemporal data). Representations that comprise representations of the same subject within the same time frame should share similar behavior data so that those representations would form a cluster that can be uniquely associated with a distinct subject. Other distinct clusters may form in the same way based on representations associated with other subjects represented in the image data 104. In some embodiments, the representation clustering 134 may apply one or more hierarchical clustering algorithms such as, but not limited to, a balanced iterative reducing and clustering using hierarchies (BIRCH) algorithm, a Ordering points to identify the clustering structure (OPTICS) algorithm, a Density-based spatial clustering of applications with noise (DBSCAN), a hierarchical DBSCAN (HDBSCAN*), an agglomerative clustering algorithm, and/or other clustering algorithms.

In some embodiments, representation clustering 134 performs a two-step hierarchical clustering process. In the first step of the clustering process, the representation clustering 134 may cluster the representations 120 based on, for example, a similarity of behavior data. This first clustering may generate a number of clusters used to determine a subject prediction number. The subject prediction number represents a prediction of how many actual subjects are represented by the representations 120 based on how many clusters form from the first step of the clustering process. The first-step clustering may be performed based on applying a fine-tuned clustering threshold parameter to the representations 120 to define how tightly clustered a set of representations may need to be (e.g., how close in distance) to be considered a cluster. The clustering threshold parameter may, in some embodiments, comprise a clustering Quality Threshold (QT) specifying a threshold distance between members of the cluster and/or a minimum number of representations that are to be within the threshold distance of each other for the set to be considered a cluster.

In some embodiments, in the second step of the clustering process, representation clustering 134 performs a second clustering of the representations 120 that comprises a constrained clustering the representations 120 based on the subject prediction number derived from the first step of the clustering process. That is, the representation clustering 134 constrains the clustering process to cluster the representations 120 into a number of clusters that corresponds to the number of subjects that are predicted to be present in the representations 120. As such, since each cluster produced by the representation clustering 134 from the second step of the clustering process is expected to comprise representations representative of the same distinct subject, both the appearance data and/or the spatiotemporal data encoded in the representations within each cluster should be highly similar—and readily distinguishable from the appearance data and the spatiotemporal data provided by the representations of other clusters that represent other distinct subjects within the monitored area.

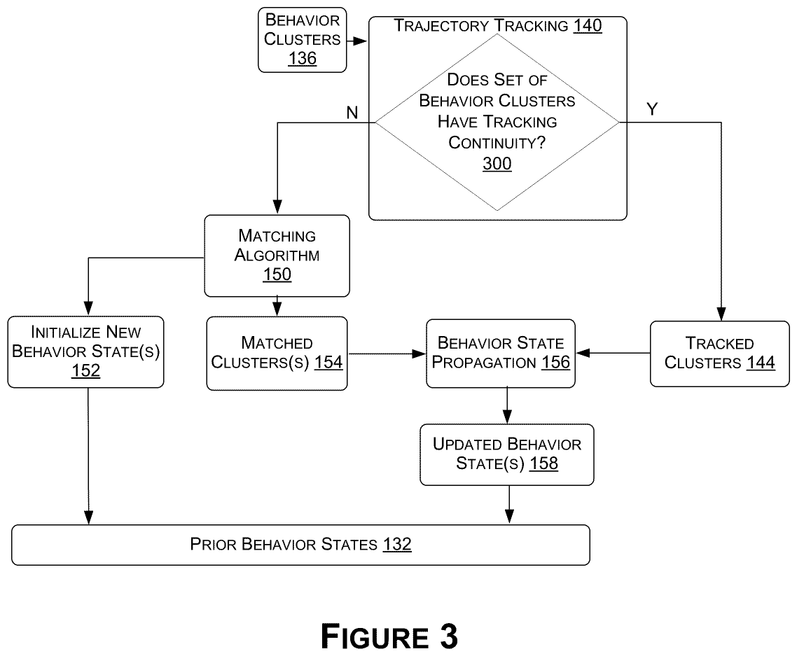

With further reference to FIG. 1, FIG. 3 is a data flow diagram illustrating operation of the behavior state management 130, in accordance with some embodiments. The behavior state management 130 may apply trajectory tacking 140 to the behavior clusters 136. If the set of behavior clusters 136 can be tracked from prior behavior states 132 using a trajectory analysis, then the behavior clusters 136 may be passed as tracked clusters 144 and the behavior state management 130 may proceed to perform behavior state propagation 156 based on the tracked clusters 144. The trajectory tracking 140 may perform a trajectory analysis, such as subject tracking continuity 300, based on the behavior data included in behavior clusters 136.

Each prior behavior state 132 may include behavior data associated with a tracked subject as determined at least from the last (e.g., most recent) prior time frame of image data 104. The trajectory tracking 140 may use the prior location and trajectory data (e.g., direction vectors) from a prior behavior state 132 to compute a predicted current location and trajectory (direction of motion) for each tracked subject given the elapsed time between iterations—and assess tracking continuity for the behavior clusters 136 based on the predicted current location and trajectory. If the magnitudes of the direction vectors indicate movement in tracked subjects, the trajectory tracking 140 may normalize the direction vectors and compute the difference between their angles. This normalized angle difference is then used as a factor to adjust the final spatiotemporal distance calculation. Behavior cluster 136 that include location and movement data within a threshold distance (e.g., a Euclidean distance) of an expected current location and trajectory computed from a prior behavior state 132 may be associated with that prior behavior state 132 and therefore used to define the set of tracked cluster(s) 144. In some embodiments, a similarity in appearance data from behavior cluster(s) 136 may be used to further validate an association between the behavior cluster 136 and prior behavior state 132. A behavior cluster 136 formed from representations 120 that represent spatiotemporal data that is within the threshold distance from a prior behavior state 132 may be associated with the global ID of that prior behavior state 132.

In some embodiments, a tracking continuity assessment may include a determination that the behavior cluster(s) 136 are associated with at least one tracked subject (e.g., as represented by at least one representation 120) represented by both a prior behavior state 132 and at least one representation 120 derived from the current time frame of image data 104. That is, as a subject moves through the monitored area and the fields of view of the various cameras, the trajectory analysis can determine if the subject appears in the streaming data feed of at least one image sensor that can be tracked from the previous batch to the current batch of image data 104. For example, if a subject appears in the streaming data feeds of image sensors, two, and three in the most recent previous time frame of synchronized optical image streaming data, and in the streaming data feeds of image sensors three, four, and/or five in current batch of synchronized optical image streaming data, then tracking continuity exists at least with respect to a cluster corresponding to that tracked subject. The representations 120 derived for that subject from the streaming data feeds of cameras four, and five should cluster with the representations 120 for that subject from image sensor three, because those embedding have similar appearance and/or spatiotemporal data. Because the representations 120 for the subject from image sensor three were previously assigned a global ID and represented by a prior behavior state 132, that global ID can be propagated forward to the current time frame and associated with the representations 120 and behavior cluster 136 for that subject derived using image sensors four and five, based on the continuity of tracking provided between batches by image sensor three.

When the behavior state management 130 determines that each of the behavior cluster 136 can be associated with a prior behavior state 132, then the set of tracked cluster(s) 144 derived from the current time frame of image data 104 may be passed to the behavior state propagation 156 to produce a set of updated behavior state(s) 158. Because the MTMC tracking system 100 is able to update the prior behavior states 132 based on trajectory tracking and/or trajectory continuity, the execution of complex matching algorithms may be avoided at least for the current time frame of image data 104.

In some embodiments, the trajectory tracking 140 may instead identify that one or more of the behavior clusters 136 cannot establish a tracking continuity with the prior behavior state 132 for the most recent prior time frame of image data 104. That is, there is a lack of tracking continuity for those one or more of the behavior clusters 136. In such cases, one or more of the behavior clusters 136 may potentially be associated with a dormant global ID. A dormant global ID (and its corresponding prior behavior state 132) may represent a subject previously observable by the optical image sensors 102, but that become non-observable (e.g., due to leaving the monitored area and/or due to an occlusion) to the optical image sensors 102. For example, one of more of the behavior clusters 136 lacking tracking continuity may potentially represent a previously known tracked subject that become temporarily been non-observable and therefore dormant, but has since again become observable within the monitored area. Moreover, one of more of the behavior clusters 136 lacking tracking continuity may potentially be associated with a new subject that is not associated with any non-expired dormant global ID and/or has not previously been tracked within the monitored area by the MTMC tracking system 100.

When the trajectory tracking 140 cannot establish tracking continuity for the set of behavior clusters 136, the behavior state management 130 may select to apply a matching algorithm 150 to the set of behavior clusters 136. The behavior clusters 136 produced by the representation clustering 134 may be used as input to the matching algorithm 150 to determine if one or more of the behavior clusters 136 match with a prior behavior sate 132 (whether for a live global ID or a dormant global ID), or potentially represent a new subject within the monitored area.

In some embodiments, the matching algorithm 150 may use an iterative matching combinatorial optimization algorithm (e.g., a matching algorithm that solves an assignment problem by matching agents to tasks) to associate a cluster from the behavior clusters 136 to a prior behavior state 132. As an example, the matching algorithm 150 may apply to the clusters a Hungarian matching algorithm, which may be referred to as a Kuhn-Munkres algorithm or a Munkres assignment algorithm. The matching algorithm 150 may assign a cluster produced by the representation clustering 134 to prior behavior state 132 by matching representations 120 that form the behavior clusters 136 to behavior data represented by prior behavior states 132 (e.g., based on similarity). The output from the matching algorithm 150 may comprise a set of matched clusters 154 that comprises a subset of the behavior clusters 136 that were successfully matched to one of the prior behavior state 132. The matched clusters 154 may then be processed by the behavior state propagation 156 to produce updated behavior state(s) 158 to propagate one or more of the prior behavior state(s) 132. In some embodiments, when a matched cluster 154 was matched to a prior behavior state 132 associated with a dormant global ID, then that dormant global ID may be reclassified back to a live global ID.

In some embodiments, the behavior state management 130 may use a configurable state retention time for determining the duration a dormant global ID can remain eligible for reclassification back to being a live global ID. If a dormant global ID has remained dormant for longer than the state retention time, then it may expire. For example, given a configurable state retention time of 10 minutes, the behavior state management 130 would trigger initialization of a new behavior state 152 for a tracked subject reappearing 15 minutes after becoming dormant. After global ID has been dormant for longer than the configurable state retention time, the behavior state management 130 may delete the dormant global ID so that it cannot be reclassified back to being a live global ID. In some embodiments, the behavior state management 130 may maintain in the prior behavior states 132 historical behavior data associated with a deleted global ID in a database for later analysis (e.g., using a QBE functionality as described below).

The behavior state propagation 156 may generate one or more updated behavior states 158 associated with the matched clusters 154. Based on the updated behavior states 158 the prior behavior states 132 associated with the matched clusters 154 may be updated to include the corresponding current behavior data based on the representations 120 represented by the matched clusters 154. In some embodiments, iterative refinement performed by the matching algorithm 150 may include a sufficient number of iterations to obtain an optimal matching accuracy saturation (e.g., approximately 10 iterations in the case of a Hungarian matching algorithm).

When the matching algorithm 150 determines that one or more of the behavior clusters 136 cannot be assigned (matched) to a prior behavior state 132, then the behavior state management 130 may initialize one or more new behavior states 152 each assigned to a new global ID, and update the set of prior behavior states 132 to include the new behavior states 152. The new behavior states 152 would become prior behavior states 132 for processing the next time frame of image data 104. In some embodiments, each new behavior state 152 may include a representation of behavior data associated with a distinct tracked subject based on representations 120 of un-matched clusters (e.g., cluster of the behavior clusters 136 that were not included in matched cluster(s) 154). At each iteration of the operation of behavior state management 130, the prior behavior states 132 may be updated to reflect newly initialized behavior states and/or updated to include current behavior data derived from the current time frame of representations 120.

Processing resources of the MTMC tracking system 100 are therefore more efficiently utilized by using the less computationally intensive trajectory tracking first to match behavior clusters 136 to prior behavior states 132, and then selectively applying the matching algorithm to the batch of behavior clusters 136 when one or more of those clusters cannot be matched using trajectory tracking. The MTMC tracking system 100 may more efficiently use computing resources to process batches (time frame) of image data 104 by applying less computationally intensive trajectory tracking when the set of tracked subjects is remaining constant from time frame to time frame. The additional processing margin obtained by more efficiently using computing resources allows for the MTMC tracking system 100 to process image data 104 from a greater number of image sensors 102 observing the given monitored area.

Returning to FIG. 1, subject tracking data 160 derived from the prior behavior states 132 (either for live global IDs and/or dormant global IDs) may be used as input, for example, by one or more subject evaluation functions 162, (e.g., analytics, query, and/or rendering systems). For example, the subject evaluation function(s) 162 may comprise a query by example (QBE) functionality, utilizing global IDs and representations produced by the MTMC tracking system 100. Representations and/or other behavior data associated with one or more tracked subjects may be stored in a database 164 (e.g., a Milvus database, vector database, and/or other vector database management system (VDBMS)) to support long-term QBE queries spanning over selected time periods. In some embodiments, the QBE functionality may operate based on representational state transfer (REST) application programming interface (API) inputs, that may include one or more of, but not limited to, an object ID, a sensor ID, a timestamp, optional parameters like time range, match score threshold, and/or top K matches, for obtaining similar behaviors. The QBE functionality may normalizes the representations 120 before searching in the database 164 for similar representations, and the matched behaviors may have IDs used by the REST API to fetch behavior metadata using a search engine (e.g., Elasticsearch). This search capability of the QBE functionality may provide for precise and efficient retrieval of relevant tracked subject behavior patterns over extended periods. In some embodiments, the subject tracking data 160 may be generated based on queries performed using the QBE functionality. In some embodiments, the one or more subject evaluation functions 162 may use subject tracking data 160 (and/or other data from the MTMC tracking system 100 representing behavior data) to control the operation of one or more machines and/or systems. For example, the subject evaluation functions 162 may control one or more operations of an AMR and/or an ego-machine, based on the location of the one or more of the tracked subjects as represented by the subject tracking data 160.

In some embodiments, the one or more subject evaluation functions 162 may include a rendering system to display via a UI a comprehensive view of the monitored area and visually render location and trajectory tracking data for each subject in the area as indicted by the subject tracking data 160. The rendering system may permit a user to switch between real and/or virtual camera views while tracking a subject moving through the monitored area, to locate a current position of a specific subject within the area (e.g., based on their global ID), and/or other applications that may benefit from having a real-time spatiotemporal understanding of the location and movements of subjects of interest within the monitored area.

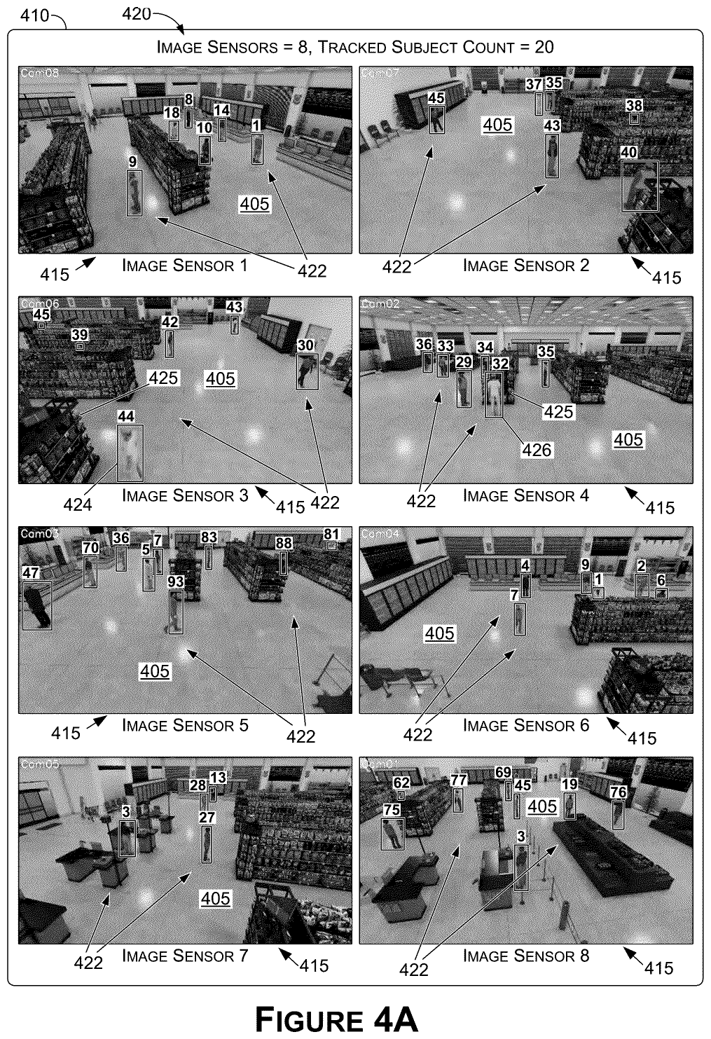

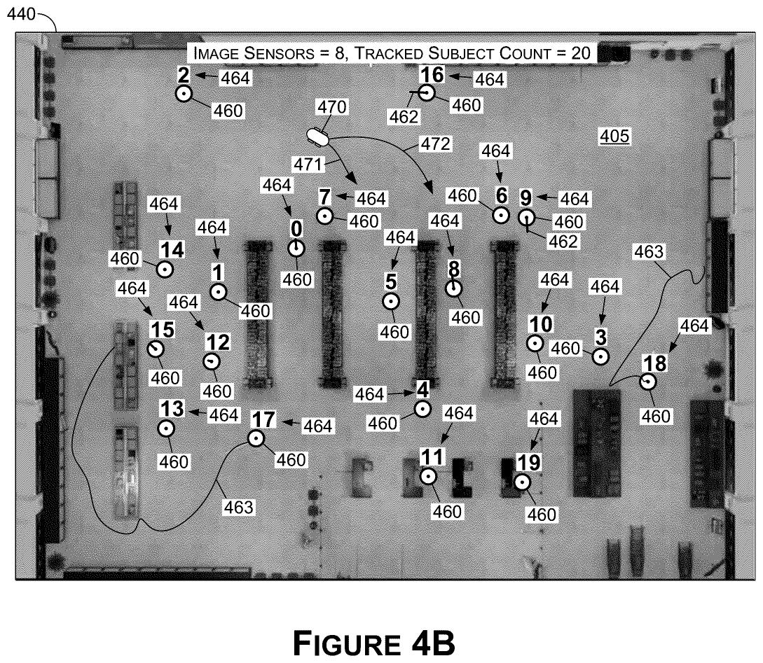

For example, FIGS. 4A and 4B are diagrams that illustrate example UIs that may be displayed using a human machine interface of the MTMC tracking system 100 (e.g., one or more of the presentation components 618 of example computing device(s) 600). In the examples of FIGS. 4A and 4B, the MTMC tracking system 100 may include a set of optical image sensors 102 that comprise eight cameras arranged to view different portions of the monitored area 405. Here, the monitored area 405 is depicted in the form of a grocery store, but it should be appreciated that in various embodiments, the monitored area 405 may comprise any area where subject tracking is desired such as, but not limited to, warehouses, factories, retail establishments, hospitals, office buildings, secured facilities, arenas, public transportation stations, parks, public spaces, and the like.

In FIG. 4A, UI display 410 presents a plurality of views 415 of the monitored area 405, referenced as Image Sensors 1-8. In some embodiments, each of the views 415 may corresponds to an image feed from a distinct one of the optical image sensors 102. In some embodiments, the MTMC tracking system 100 may generate one or more of the views 415 as a display of a computer-vision based environment corresponding to a viewpoint of one or more of the real image sensors 102, and/or of a viewpoint of one or more virtual camera views instantiated within the computer-vision based environment.

As shown in FIG. 4A, each of the views 415 may present a plurality of behaviors 422 each corresponding to a tracked subject within the view of the respective image sensor 102. Moreover, for each of the behaviors 422, the MTMC tracking system 100 may extract behavior data and generate a corresponding one of the representations 120. Across the eight image sensors, 20 tracked subjects are present and observable within the monitored area 405, so that up to 160 representations 120 may be expected to be generated by the behavior extraction 110. However, in reality the number of representations 120 may be expected to be fewer since each of the 20 tracked subjects are not likely to be observable by all 8 image sensors at the same time. In this example, six behaviors are observable from images sensor 1, six behaviors are observable from image sensor 2, six behaviors are observable from image sensor 3, six behaviors are observable from image sensor 4, nine behaviors are observable from image sensor 5, six behaviors are observable from image sensor 6, five behaviors are observable from image sensor 7, and eight behaviors are observable from image sensor 8. As such, in total, the behavior extraction 110 processing these image feeds may detect 52 distinct behaviors 422 and accordingly generate 52 representations 120. In other embodiments, the MTMC tracking system 100 may obtain image data 104 from a greater or fewer number of optical image sensors 102 and display views for one or more view from that image data as illustrated in FIG. 4A.

As discussed herein, similarities between the behaviors 422 may be used to associate behaviors to individual tracked subjects. For example, image sensor 3 captures a behavior 424 located at an isle end cap 425 that similar in appearance to a corresponding behavior 426 captured by image sensor 4 located at the isle end cap 425. As such, representations for behavior 424 and behavior 426 would be similar with respect to appearance data and/or spatiotemporal data, and will cluster together based on similarity. The representations for behavior 424 and behavior 426 may therefore both be assigned to the same behavior state and/or global ID. In some embodiments, the MTMC tracking system 100 may display a global ID (or other individual identifier) assigned to a tracked subject, next to their behaviors as displayed in one or more of the views 415. In some embodiments, UI display 410 may include an information field 420 displaying information about observed tracked subjects, such as the number of tracked subjects presented across the multiple views 415 and/or the number of image sensors 102 contributing optical image data 104 to the MTMC tracking system 100 to produce the views 415.

FIG. 4B is an example UI display 440 presenting a top down view of the monitored area 405. In some embodiments, the UI display 440 presents virtual subjects 460 at the positions of individual tracked subjects corresponding to the global IDs produced by the MTMC tracking system 100, and based on the behavior data represented by the behavior states. Each of the 52 representations 120 produced from the multiple image sensor data feeds illustrated in FIG. 4A are clustered and associated with a global ID by the behavior state management 130, and rendered as a virtual subject 40 in FIG. 4B. The spatiotemporal data for each behavior 424 from the views 415 has been mapped to a global coordinate system of the monitored area 405 so that the position of tracked subjects may be presented using the virtual subjects 460 with respect to a common frame of reference within the UI display 440.

As the prior behavior states 132 are propagated, the MTMC tracking system 100 may update the position and/or appearance of each virtual subject 460 representation of a tracked subject within the UI display 440. For each virtual subject 460, the UI display 440 may include the global ID 464 assigned to the corresponding tracked subject. The global ID 464 may be an anonymized identifier, and/or may correlate to a more personal identifier such as a subject's name, employee number, customer number, account number, student number, and/or other identifier associated with a tracked subject.

In some embodiments, for one or more of the virtual subjects 460, the MTMC tracking system 100 may update a path indicator 462 that illustrates a tracked subject's past positions and/or movements over a selectable duration of time. The UI display 440 may present the complete trajectories, or a subset thereof, for one or more of the subjects tracked and displayed as virtual subjects 460 for the current batch (time frame) of image data 104. In some embodiments, the UI display 440 may highlight each trajectory individually based on an input from the user. For example, UI display at 463 shows example extended trajectories that may presented for one or more of the virtual subjects 460 (subjects 17 and 18 in this example) going back a duration that may be selectable by a user.

In some embodiments, the MTMC tracking system 100 may present UI displays of virtual subjects 460 using live and past viewing modes. For example, the UI may start in a live mode displaying recent MTMC events (e.g., actions of tracked subjects) for tracked subjects that are updated continuously at regular intervals. The subject trajectories associated with prior MTMC events for one or more subjects may also be plotted and updated (e.g., at a predetermined frequency) on the UI display (e.g., such as UI display 410, UI display 440 or other UI display). QBE may be performed based on any of the UI displays presented by the MTMC tracking system 100, for example using a QBE widget displayed on the UI.

As discussed herein, the subject evaluation functions 162 may control one or more operations of an AMR and/or an ego-machine, based on the location of the one or more of the tracked subjects as represented by the subject tracking data 160. For example, the MTMC tracking system 100 may periodically generate updates to behavior states at frequencies (e.g., every 30 seconds) which may be used to plan routing for AMRs travelling long distances and/or where more immediate updates for subject behaviors are not as consequential. In some embodiments, the UI display 440 may display the positions and/or movements of virtual subjects 460 representing tracked subjects in the monitored area 405 in relation to the positions and/or movements of one or more AMR 470. In some embodiments, the UI display 440 may display alternate routes 471 and 472 for navigating the AMR 470 through the monitored area that avoid congestion and/or avoid interactions with tracked subjects, and/or display route-changing events due to blockages.

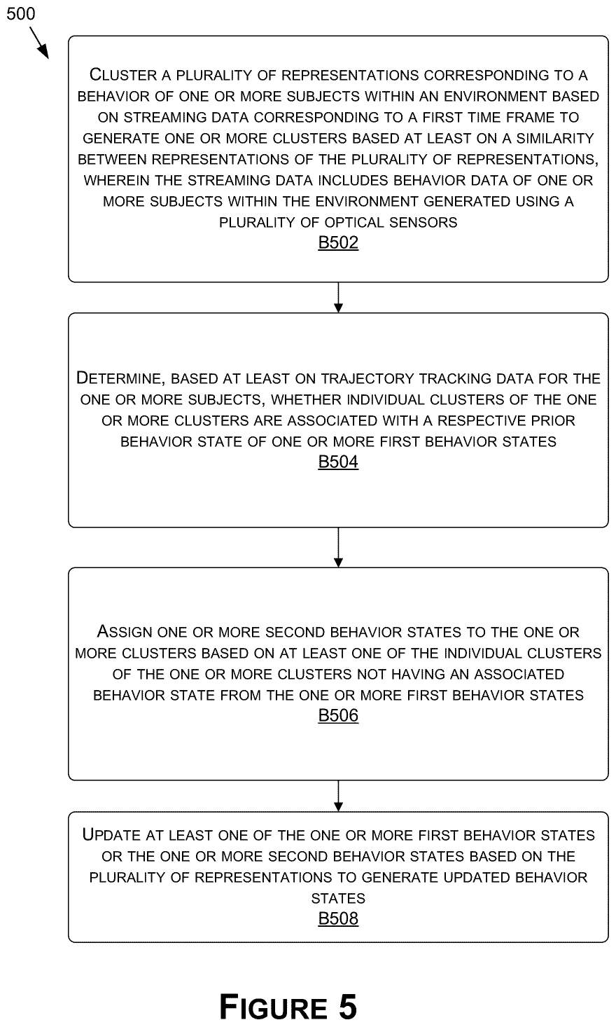

FIG. 5 is a flow diagram showing a method 500 for multi-subject multi-camera tracking for high-density environments, in accordance with some embodiments of the present disclosure. It should be understood that the features and elements described herein with respect to the method 500 of FIG. 5 may be used in conjunction with, in combination with, or substituted for elements of any of the other embodiments discussed herein and vice versa. Further, it should be understood that the functions, structures, and other descriptions of elements for embodiments described in FIG. 5 may apply to like or similarly named or described elements across any of the figures and/or embodiments described herein and vice versa. Each block of method 500, described herein, comprises a computing process that may be performed using any combination of hardware, firmware, and/or software. For instance, various functions may be carried out by one or more processors comprising processing circuitry to execute instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 500 is described, by way of example, with respect to the MTMC tracking system 100 of FIG. 1. However, the method may additionally or alternatively be executed by any one system, or any combination of systems, including, but not limited to, those described herein.

As discussed herein in greater detail, in some embodiments the method may include generating behavior states representing behavior data for one or more tracked subjects within an environment based on clustering a plurality of representations computed from optical image streaming data representing the environment, wherein the behavior states are updated using the plurality of representations by: associating, based at least on trajectory tracking data, one or more clusters of the plurality of representations with one or more first behavior states computed from the optical image streaming data; and applying a matching algorithm to assign one or more second behavior states to the one or more clusters based on at least one individual cluster of the plurality of representations not having an associated behavior state from the one or more first behavior states.

The method 500, at block B502, includes clustering a plurality of representations corresponding to a behavior of one or more subjects within an environment based on streaming data corresponding to a first time frame to generate one or more clusters based at least on a similarity between representations of the plurality of representations, wherein the streaming data includes behavior data of one or more subjects within the environment generated using a plurality of optical sensors. The streaming data may include behavior data captured from a plurality of optical sensors and represents one or more tracked subjects within a monitored area. The one or more clusters may individually represent an individual tracked subject of the one or more tracked subjects. As discussed above, the MTMC tracking system 100 may include behavior extraction 110 that operates to produce representations 120 based on image data 104, where the image data 104 represents a monitored area as captured by a plurality of optical image sensors 102. The image data may include synchronized optical image streaming data based on streaming feeds from the plurality of optical image sensors. The streaming data may comprise synchronized optical image streaming data that includes individual image feeds from the plurality of optical sensors, wherein at least two optical sensors of the plurality of optical sensors are synchronized to capture the individual image feeds at the same time. In some embodiments, the image data includes synchronized optical image streaming data based on batches of previously recorded live-streaming feeds from the plurality of optical image sensors. The MTMC tracking system 100 may process the image data as sequential batches, for example where each micro-batch defines a distinct sub-second time frame of the image data. The image data may be processed using behavior extraction to extract representations that represent individual behaviors of tracked subjects represented in the image data. The behavior data comprises one or both of appearance data and spatiotemporal data represented by the plurality of representations.

The plurality of representations may be generated based on processing individual data feeds from at least one individual sensor of the plurality of optical sensors, such as illustrated in FIG. 2. The behavior extraction 110 may implement a plurality of parallel data processing paths 228, where each path 228 may independently process a feed of the image data 104 associated with one of the optical image sensors 102. Within each path 228, the behavior extraction 110 may perform behavior detection 222, behavior tracking 224 and/or behavior encoding 226. In some embodiments, the plurality of representations may be generated using a machine learning model trained to detect one or more characteristics representing the one or more tracked subjects based on the streaming data. The behavior encoding model 220 may comprise, for example, a re-identification (Re-ID) embedding model that encodes the appearance of each tracked subject appearing in the image data 104 carried by the processing paths 228, as discussed with respect to FIG. 2. The resulting plurality of representations may be mapped to a global image coordinate system based on camera calibration parameters associated with the plurality of optical sensors.

Clustering a plurality of representations may be performed using representation clustering 134 as discussed herein. Representation clustering 134 may perform a clustering of the representations 120 based on similarity of behavior data (e.g., appearance data and/or spatiotemporal data). Representations that comprise representations of the same subject within the same time frame should share similar behavior data so that those representations would form a cluster that can be uniquely associated with a distinct subject. Other distinct clusters may form in the same way based on representations associated with other subjects represented in the image data 104. In some embodiments, the representation clustering 134 may apply one or more hierarchical clustering algorithms such as, but not limited to, a balanced iterative reducing and clustering using hierarchies (BIRCH) algorithm, a Ordering points to identify the clustering structure (OPTICS) algorithm, a Density-based spatial clustering of applications with noise (DBSCAN), a hierarchical DBSCAN (HDBSCAN*), an agglomerative clustering algorithm, and/or other clustering algorithms. In some embodiments, representation clustering comprises a two-step hierarchical clustering process. A subject prediction number may be determined based on a first clustering process that clusters the plurality of representations based at least on a similarity of representations from the plurality of representations; and a second clustering process applied to the plurality of representations that is constrained to cluster the plurality of representations based at least on the subject prediction number.

The method 500, at block B504, includes determining, based at least on trajectory tracking data for the one or more subjects, whether individual clusters of the one or more clusters are associated with a respective prior behavior state of one or more first behavior states. The first plurality of prior behavior states may be derived using a second time frame of the streaming data occurring prior to the first time frame. In some embodiments, behavior state management 130 may apply trajectory tacking 140 to the behavior clusters 136. If the set of behavior clusters 136 can be tracked from prior behavior states 132 using a trajectory analysis, then the behavior clusters 136 may be passed as tracked clusters 144 and the behavior state management 130 may proceed to perform behavior state propagation 156 based on the tracked clusters 144. The trajectory tracking 140 may perform a trajectory analysis, such as subject tracking continuity 300, based on the behavior data included in behavior clusters 136. The trajectory tracking 140 may use the prior location and trajectory data to compute a predicted current location and trajectory for each tracked subject given the elapsed time between iterations—and assess a tracking continuity for the behavior clusters 136 based on the predicted current location and trajectory. The method may associate individual behavior states from at least one of the one or more first behavior states or the one or more second behavior states with a global identifier (ID).

The method 500, at block B506, includes assigning one or more second behavior states to the one or more clusters based on at least one of the individual clusters of the one or more clusters not having an associated behavior state from the one or more first behavior states. The second plurality of prior behavior states may be derived using one or more time frames of the streaming data occurring prior to the first time frame. When the trajectory tracking cannot establish tracking continuity for the set of behavior clusters 136, the behavior state management 130 may select to apply a matching algorithm 150 to the set of behavior clusters 136. The behavior clusters 136 produced by the representation clustering 134 may be used as input to the matching algorithm 150 to determine if one or more of the behavior clusters 136 match with a prior behavior sate 132 (whether for a live global ID or a dormant global ID), or potentially represent a new subject within the monitored area. The matching algorithm comprises at least one of: an iterative matching combinatorial optimization algorithm, an algorithm that solves an assignment problem by matching agents to tasks, a Hungarian matching algorithm, a Kuhn-Munkres algorithm, or a Munkres assignment algorithm.

The method 500, at block B508, includes updating update at least one of the one or more first behavior states or the one or more second behavior states based on the plurality of representations to generate updated behavior states. As described herein, if the set of behavior clusters 136 can be tracked from prior behavior states 132 using a trajectory analysis, then the behavior clusters 136 may be passed as tracked clusters 144 and the behavior state management 130 may proceed to perform behavior state propagation 156 based on the tracked clusters 144. If not, then matched clusters 154 may then be processed by the behavior state propagation 156 to produce updated behavior state(s) 158 to propagate one or more of the prior behavior state(s) 132. The one or more second behavior states may be assigned to the one or more clusters using a matching algorithm. One or more new behavior states may be initialized for at least one cluster of the one or more clusters based on the at least one cluster not being assigned to at least one of the one or more second behavior states by the matching algorithm. The method may further include applying a linear programming algorithm to implement overlapping behavior suppression to avoid associating multiple clusters of the one or more clusters with more than one of the one or more tracked subjects. Based on the updated behavior states, prior behavior states may be updated to include the corresponding current behavior data based on current representations.

Subject tracking data derived from the behavior states may be used as input, for example, by one or more subject evaluation functions (e.g., analytics, query, and/or rendering systems). As discussed herein, the subject evaluation function(s) may comprise a query by example (QBE) functionality, utilizing global IDs and representations produced by the MTMC tracking system. Representations and/or other behavior data associated with one or more tracked subjects may be stored in a database (e.g., a Milvus database, vector database, and/or other vector database management system (VDBMS)) to support long-term QBE queries spanning over selected time periods. The subject tracking data may be generated based on queries performed using the QBE functionality. In some embodiments, the one or more subject evaluation functions may use subject tacking data (and/or other data from the MTMC tracking system representing behavior data) to control the operation of one or more machines and/or systems. In some embodiments, the subject evaluation functions may control one or more operations of an AMR and/or an ego-machine, based on the location of the one or more of the tracked subjects as represented by the subject tracking data. In some embodiments, the one or more subject evaluation functions 162 may include a rendering system to display via a UI a comprehensive view of the monitored area and visually render location and trajectory tracking data for each subject in the area as indicted by the subject tracking data, such as discussed with respect to FIGS. 4A and 4B. The UI may comprise a computer vision-based view of the one or more tracked subjects for at least a portion of the monitored area based at least on the updated behavior states.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs), systems for performing light transport simulation, systems for performing collaborative content creation for 3D assets, systems implemented at least partially using cloud computing resources, and/or other types of systems.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof. In some embodiments, one or more elements of the MTMC tracking system 100 discussed herein may be implemented by one or more of computing device(s) 600 (e.g., as code executed by computing device(s) 600, for example using CPUs 606 and/or GPUs 608)

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that allow the computing device 600 to communicate with other computing devices via an electronic communication network, included wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.). In some embodiments, one or more UI used in conjunction with the MTMC tracking system 100 may be displayed using one or more of the presentation component(s) 618.

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM). In some embodiments, one or more functions of the MTMC tracking system 100 disclosed herein may be implemented as code executed by computing device(s) 600, for example using one or more of the node C.R.s 716(1)-716(N).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may use distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources. In some embodiments, on or more functions of the MTMC tracking system 100 disclosed herein may be implemented using one or more application(s) 742 and/or software 732.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
cluster a plurality of representations corresponding to a behavior of one or more subjects within an environment based on streaming data corresponding to a first time frame to generate one or more clusters based at least on a similarity between representations of the plurality of representations, wherein the streaming data includes behavior data of one or more subjects within the environment generated using a plurality of optical sensors;
determine, based at least on trajectory tracking data for the one or more subjects, whether individual clusters of the one or more clusters are associated with a respective prior behavior state of one or more first behavior states;
assign one or more second behavior states to the one or more clusters based on at least one of the individual clusters of the one or more clusters not having an associated behavior state from the one or more first behavior states; and
update at least one of the one or more first behavior states or the one or more second behavior states based on the plurality of representations to generate updated behavior states.

2. The one or more processors of claim 1, wherein the one or more second behavior states are assigned to the one or more clusters using a matching algorithm, and wherein the processing circuitry is further to:
initialize a new behavior state for at least one cluster of the one or more clusters based on the at least one cluster not being assigned to at least one of the one or more second behavior states by the matching algorithm.

3. The one or more processors of claim 1, wherein the behavior data comprises at one or both of appearance data and spatiotemporal data represented by the plurality of representations.

4. The one or more processors of claim 1, wherein the processing circuitry is further to:
generate the plurality of representations based on processing individual data feeds from at least one individual sensor of the plurality of optical sensors.

5. The one or more processors of claim 1, wherein the processing circuitry is further to:
generate the plurality of representations using a machine learning model trained to detect one or more characteristics representing the one or more subjects based on the streaming data.

6. The one or more processors of claim 1, wherein the streaming data comprises synchronized optical image streaming data that includes individual image feeds from the plurality of optical sensors, wherein at least two optical sensors of the plurality of optical sensors are synchronized to capture the individual image feeds at the same time.

7. The one or more processors of claim 1, wherein the processing circuitry is further to:
map the plurality of representations to a global image coordinate system based at least on camera calibration parameters associated with the plurality of optical sensors.

8. The one or more processors of claim 1, wherein the plurality of representations individually represent one or both of appearance data and spatiotemporal data for a respective subject of the one or more subjects.

9. The one or more processors of claim 1, wherein the processing circuitry is further to:
associate individual behavior states from at least one of the one or more first behavior states or the one or more second behavior states with a global identifier (ID).

10. The one or more processors of claim 1, wherein the processing circuitry is further to cluster the plurality of representations based on a hierarchical clustering process that performs operations to:
determine a subject prediction number based on a first clustering process that clusters the plurality of representations based at least on a similarity of representations from the plurality of representations; and
apply, to the plurality of representations, a second clustering process that is constrained to cluster the plurality of representations based at least on the subject prediction number.

11. The one or more processors of claim 2, wherein the matching algorithm comprises at least one of:
an iterative matching combinatorial optimization algorithm;
an algorithm that solves an assignment problem by matching agents to tasks;
a Hungarian matching algorithm;
a Kuhn-Munkres algorithm; or
a Munkres assignment algorithm.

12. The one or more processors of claim 1, wherein the processing circuitry is further to apply a linear programming algorithm to implement overlapping behavior suppression to avoid associating multiple clusters of the one or more clusters with more than one of the one or more subjects.

13. The one or more processors of claim 1, wherein the processing circuitry is further to cause a display of a computer vision-based view of the one or more subjects for at least a portion of the environment based at least on the updated behavior states.

14. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

15. A system comprising one or more processors to:
generate one or more clusters using a plurality of representations computed based on optical image streaming data representing one or more tracked subjects within a monitored area;
associate, based at least on trajectory tracking data, individual clusters of the one or more clusters with a respective behavior state of one or more first behavior states computed from the optical image streaming data;
assign, using a matching algorithm, one or more second behavior states to the one or more clusters based on at least one of the individual clusters not having an associated behavior state from the one or more first behavior states; and
update at least one behavior state of the one or more first behavior states or the one or more second behavior states based on behavior data represented by the plurality of representations.

16. The system of claim 15, wherein the one or more processors are further to:
generate the plurality of representations using a machine learning model trained to detect one or more characteristics representing the one or more tracked subjects based on the optical image streaming data.

17. The system of claim 15, wherein the one or more processors are further to cluster the plurality of representations based on a hierarchical clustering process to:
determine a subject prediction number based on a first clustering process that clusters the plurality of representations based at least on a similarity of representations; and
apply, to the plurality of representations, a second clustering process is constrained to cluster the plurality of representations based at least on the subject prediction number.

18. The system of claim 15, wherein the matching algorithm comprises at least one of:
an iterative matching combinatorial optimization algorithm;
an algorithm that solves an assignment problem by matching agents to tasks;
a Hungarian matching algorithm;
a Kuhn-Munkres algorithm; or
a Munkres assignment algorithm.

19. The system of claim 15, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

20. A method comprising:
generating behavior states representing behavior data for one or more tracked subjects within an environment based on clustering a plurality of representations computed from optical image streaming data representing the environment, wherein the behavior states are updated using the plurality of representations by:
associating, based at least on trajectory tracking data, one or more clusters of the plurality of representations with one or more first behavior states computed from the optical image streaming data; and
applying a matching algorithm to assign one or more second behavior states to the one or more clusters based on at least one individual cluster of the plurality of representations not having an associated behavior state from the one or more first behavior states.
